(19) United States
(12) Patent Application Publication
(10) Pub. No.: US 2021/0326262 A1
(43) Pub. Date: Oct. 21, 2021

(54) LOW LATENCY METRICS SHARING ACROSS PROCESSOR UNITS

(71) Applicants: David Hunt, Meelick (IE); Jeffrey B. Shaw, Portland, OR (US); Tewodros A. Wolde, Beaverton, OR (US); Paul Hough, Newcastle West (IE); Biwei Guo, Portland, OR (US); John J. Browne, Limerick (IE); Liang Ma, Shannon (IE); Sunku Ranganath, Beaverton, OR (US); Chris M. MacNamara, Ballyclough (IE)

(72) Inventors: David Hunt, Meelick (IE); Jeffrey B. Shaw, Portland, OR (US); Tewodros A. Wolde, Beaverton, OR (US); Paul Hough, Newcastle West (IE); Biwei Guo, Portland, OR (US); John J. Browne, Limerick (IE); Liang Ma, Shannon (IE); Sunku Ranganath, Beaverton, OR (US); Chris M. MacNamara, Ballyclough (IE)

(21) Appl. No.: 17/358,781

(22) Filed: Jun. 25, 2021

(51) Int. Cl. G06F 12/0842; G06F 3/06

(52) U.S. Cl. CPC G06F 12/0842; G06F 3/0655; G06F 2212/62; G06F 3/0604; G06F 3/0679

(57) ABSTRACT

A system comprising a first processor unit comprising a first register to store a metric for the first processor unit; and circuitry to initiate sharing of the metric with a second processor unit without the use of an inter-processor interrupt.

### BACKGROUND

A computing system may comprise multiple processor units. Some of the processor units may execute respective workloads and one or more other processor units may monitor conditions of the system and adjust operating parameters based on the conditions.

### BRIEF DESCRIPTION OF THE DRAWINGS

FIG. 1 illustrates a computing system providing low latency metrics sharing across processor units in accordance with certain embodiments.

FIG. 2 illustrates another computing system providing low latency metrics sharing across processor units in accordance with certain embodiments.

FIG. 3 illustrates a data flow of a computing system providing low latency metrics sharing across processor units in accordance with certain embodiments.

FIG. 4 illustrates a first flow for providing low latency metrics sharing across processor units in accordance with certain embodiments.

FIG. 5 illustrates a second flow for providing low latency metrics sharing across processor units as part of a workload in accordance with certain embodiments.

FIG. 6 illustrates a block diagram of a processor with a plurality of cache agents and caches in accordance with certain embodiments.

FIG. 7 illustrates a second example computing system in accordance with certain embodiments.

FIG. 8 illustrates an example data center in accordance with certain embodiments.

FIG. 9 illustrates an example rack architecture in accordance with certain embodiments.

FIG. 10 illustrates an example computing environment in accordance with certain embodiments.

FIG. 11 illustrates an example network interface in accordance with certain embodiments.

Like reference numbers and designations in the various drawings indicate like elements.

### DETAILED DESCRIPTION

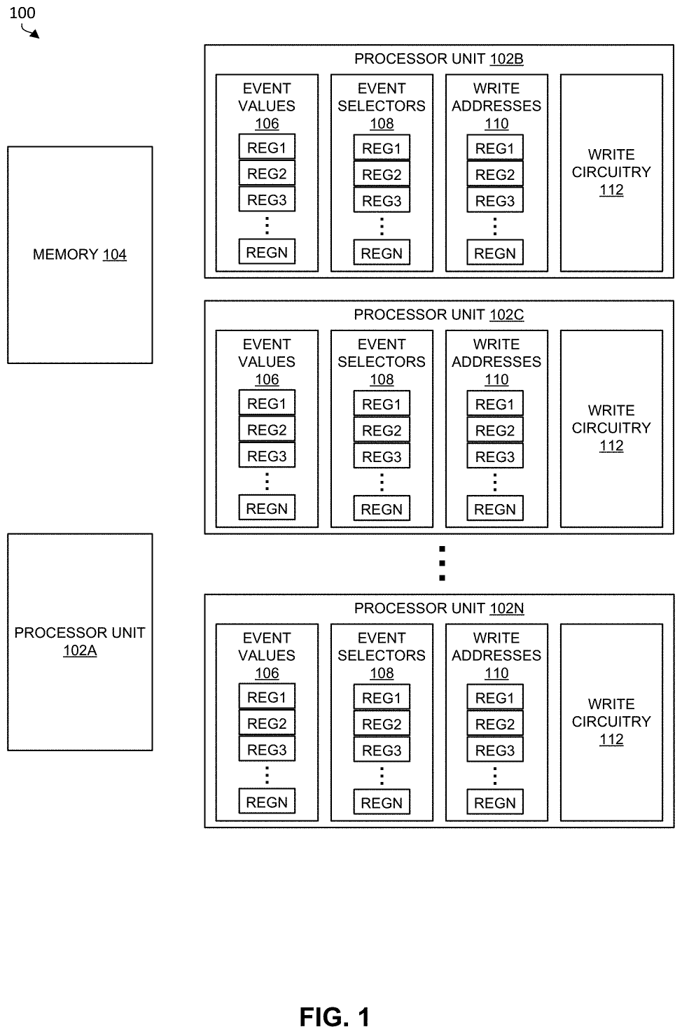

FIG. 1 illustrates a computing system 100 providing low latency metrics sharing across processor units in accordance with certain embodiments. System 100 includes a plurality of processor units 102 (e.g., 102A through 102N) and a memory 104 accessible by the plurality of processor units 102. Processor units 102B through 102N each comprise event value registers 106, event selector registers 108, and write address registers 110. In the embodiment depicted, each set of these registers includes registers reg1 through regN. Processor units 102B through 102N also each comprise write circuitry 112.

In operation, processor units 102B through 102N may execute any suitable workloads. A processor unit 102 may track various metrics for operations performed by or conditions associated with the processor unit 102. When a workload is running on a processor unit 102, exposing the processor unit's metrics to one or more remote processor units may be advantageous for various reasons. In some embodiments, a particular processor unit 102A may read the metrics of the other processor units 102B-N and make system level decisions based thereon. For example, the processor unit 102A may use the metrics of one or more of the processor units 102B-N to cause a change in frequency or power state of one or more of the processor units 102, to schedule workloads (e.g., in some embodiments, a software kernel may be running on processor unit 102A and may implement a scheduler for the other processor units 102B-N), or to analyze how algorithms perform on different processor units under various working conditions, among others.

Embodiments of the present disclosure provide for low latency reads of the metrics of one or more processor units (e.g., processor units 102B-N) by a remote processor unit (e.g., processor unit 102A). In various embodiments, write circuitry 112 of a processor unit 102 may proactively initiate the writing of the processor unit's metrics to a memory 104 (e.g., an L3 cache) that is accessible by the processor unit 102A that is to read the metrics. For example, a processor unit 102 may periodically cache (e.g., in an L1 cache of the respective processor unit 102) the metrics (which may be stored in event value registers 106) and the metrics may then be written to a lower level cache (e.g., an L3 cache) that is accessible by processor unit 102A. In various embodiments, the processor unit 102A may access the metrics directly from the memory 104. Thus, one or more embodiments described herein may provide an alternative to obtaining a metric using an inter-processor interrupt (e.g., caused by processor unit 102A requesting that another processor unit 102 issue a read instruction such as Read from Model Specific Register (RDMSR) for the desired metric from the processor unit 102) and its associated latency (e.g., ˜3,000 to 4,000 cycles for context switches and operations involved in performing the read instruction) and disruption to the workload performance (e.g., a single inter-processor interrupt could add roughly 2 microseconds of jitter to the workload). In other embodiments, the processor unit 102A may read or otherwise obtain the metrics from a different level of memory (e.g., an L1 cache of the other processor unit 102, an L4 cache, a main memory, etc.) while still avoiding use of inter-processor interrupts, resulting in faster access and less intrusion to the other processor unit 102.

The memory 104 may represent any suitable storage of the computing system 100 that may be accessed by the processor units 102. In an embodiment, memory 104 is an L3 cache that is shared by the various processor units 102. In another embodiment, memory 104 may be an L4 cache or main memory of the computing system 100 (which may lead to slower access by processor unit 102A, but may still be faster than obtaining the metric through an inter-processor interrupt).

In the description below, operations and characteristics of processor unit 102B are disclosed. In various embodiments, these operations and characteristics may apply to any (or all) of the other processor units 102 of the computing system 100.

In the embodiment depicted, each processor unit 102 includes a plurality of event value registers 106 to store event values, a plurality of event selector registers 108 to store event selectors, and a plurality of write address registers 110 to store write addresses. In one embodiment, the event value, event selector, and write address registers are model-specific registers (MSRs). MSRs may be distinguished from general purpose registers and floating point registers of the processor unit. In a particular embodiment, the MSRs may be read by using a RDMSR instruction and written to using a Write to Model Specific Register (WRMSR) instruction. MSRs may be organized into an array of registers to serve any suitable functions. MSRs may allow a central processing unit (CPU) designer to add microarchitecture functionality without having to add an additional instruction to the CPU instruction set.

In various embodiments, an event value register 106 may be associated with an event selector register 108 and/or a write address register 110. For example, the REG 1 of event value registers 106 may be associated with the REG1 of the event selector registers 108 and/or the each REG1 of the write address registers 110, the REG 2 of event value registers 106 may be associated with the REG2 of the event selector registers 108 and/or the each REG2 of the write address registers 110, and so on. Various embodiments may include any number of registers 106, 108, and 110. In some embodiments, each of registers 106, 108, and 110 include 4 registers or 8 registers.

An event selector register 108 may store a value that indicates an event for which the corresponding event value register 106 stores a metric, such as a counter, status, or other suitable metric associated with a condition of the processor unit 102B. In various embodiments, the processor unit 102B may be capable of tracking any suitable number of different events and may be configured to track a subset of these events using event value registers 106. For each event to be tracked, an event selector register 108 may be set to store an indication of the event and the metric for the event is stored in the associated event value register. A few examples of events that may be tracked include branch hits, branch misses, number of instructions retired, power usage, L3 cache hits, page faults, context switches, central processing unit thread migrations, and number of processor unit cycles.

In some embodiments, the value in an event value register 106 may represent a counter that indicates how many times the event (defined in the associated event selector register 108) has occurred. For example, REG1 of event selector registers 108 may store an identifier of branch hits and REG1 may store a counter for the number of branch hits. In some embodiments, the event selector registers 108 are named IA32_PERFEVTSELx, where “x” is the number of the event selector register 108.

In some embodiments, processor unit 102A may communicate with processor unit 102B to instruct the processor unit 102B as to which events should be tracked using the event value registers 106 and the corresponding event identifiers may be stored in the event selector registers 108.

Processor unit 102B may also include write address registers 110. A write address register 110 may store a memory address to which the event value of the corresponding event value register 106 is to be periodically written to. The memory address may refer to a location within one or more various memory structures (e.g., memory 104) of the memory hierarchy of the computing system 100. For example, the memory address may refer to a location within an L1 cache of the processor unit 102B, an L2 cache, an L3 cache, an L4 cache, a main memory, each of these, or any subset thereof.

In some embodiments, instead of a write address register 210 for each event value register 206, processor unit 202B may include a single write address register 210 to store a memory address for a first event value (e.g., REG1 of event value registers 206), and the remaining event values may be written to the consecutive memory addresses following the write address.

Write circuitry 112 may include circuitry to periodically initiate a write of the value stored in an event value register 106 to the corresponding memory address stored in a write address register 110. Periodic in this sense refers to an operation that occurs at intervals that may or may not be equal. The write circuitry 112 may initiate the writing of the values to the memory addresses at any suitable intervals. For example, the write circuitry 112 may initiate the writing at equal interviews, such as every few microseconds, every 100 microseconds, or at other equal intervals. In one embodiment, the writing may be controlled by a timer in the processor that is dedicated for this purpose or that is used for another purpose and is leveraged by the write circuitry 112. For example, a hysteresis timer for limiting how often a frequency of the processor 102B may be changed could be used (this timer may be configurable to tick, e.g., every 50 microseconds, 500 microseconds, etc.) As another example, the write circuitry 112 may initiate the writing upon a trigger, which may result in unequal intervals in between initiation of the writes. For example, the write circuitry 112 may leverage a counter that is being used for another purpose (e.g., to track an event) to trigger the initiation of the writing. In one embodiment, the write circuitry 112 may include one or more timers or counters that trigger the initiation of the writing.

The write circuitry 112 may initiate the writing of each of the event values of registers 106 to the memory addresses using the same intervals (such that all of the event values are written together or in sequential operations), or the write circuitry 112 could initiate the writing of one or more of the event values of registers 106 at different intervals than the initiation of the writing of one or more of the other event values.

In various embodiments, the write circuitry 112 may initiate the writing of the event values of registers 106 at intervals that are shorter than the intervals used by the processor unit 102A to retrieve the values from memory 104 (or other memory location, such as the L1 cache of the other processor unit 102) to promote the provision of updated data to the processor unit 102A.

The event values in registers 106 may be updated at any suitable interval. For example, in one embodiment, each time an event value changes, an updated event value may be written to the corresponding event value register 106. For event values that are rapidly increasing or otherwise frequently changing, the event value registers 106 may be updated many times in between instances of being written to a memory (e.g., memory 104) based on their respective memory addresses.

In some embodiments, if a particular write address register 110 stores an address of 0 (or some other predetermined value), then the writing of the corresponding event value is disabled and write circuitry 112 will not initiate writing of that value to memory 104 (in some embodiments, the value in the corresponding event value register 106 could still be read by the processor unit 102A, e.g., using a RDMSR instruction or other suitable read instruction).

In a particular embodiment, processor unit 102A may communicate with processor unit 102B and may specify the addresses to be stored in write address registers 110 (and thus processor unit 102A may know which event values are stored at which memory addresses prior to accessing the event values from memory 104). In another embodiment (e.g., if processor unit 102B configures the memory addresses in write address registers 110 by itself), processor unit 102A may read the write address registers 110 of processor unit 102B and store the addresses for use in accessing the event values from memory 104.

In one embodiment, initiating the writing of a value stored in an event value register 106 to the corresponding memory address comprises initiating the writing of the value stored in the event value register 106 to an L1 cache of the processor unit 102B. The values stored in event value registers 106 may be written to the L1 cache of the processor unit 102B using any suitable circuitry. In various embodiments, write circuitry 112 may include microcode or other suitable circuitry (e.g., circuitry outside of the instruction execution unit) of the processor unit 102B that, at regular intervals, reads the event value registers 106 and writes the values to the corresponding memory locations (thus causing the values to be written to an L1 cache of processor unit 102B).

In some embodiments, initiating the writing of the value to the corresponding memory address also includes one or more actions promoting the writing of the metrics to the memory 104 (e.g., L3 cache). For example, write circuitry 112 may be operable to execute an instruction (e.g., a cache line demote (CLDEMOTE) instruction) or perform a function similar to the execution of such an instruction for a cacheline at which the event value has been stored in the L1 cache. For example, the write circuitry 112 may provide a hint (e.g., to other circuitry such as a cache or memory controller or agent) of the system 100 that a cache line including one or more metrics should be moved (“demoted”) from the cache(s) closest to the processor unit 102B to a memory level (e.g., a lower level cache such as memory 104 which could be an L3 cache) more distant from the processor unit 102B. This may speed up subsequent accesses to the cache line by other processor units (e.g., processor unit 102A) in the same coherence domain. In various embodiments, the other circuitry of the system 100 may decide on which level in the memory hierarchy the cache line is retained (and calling CLDEMOTE or performing similar actions by write circuitry 112 may not be a guarantee that the cache line will be moved to a more distant cache). In other embodiments, the write circuitry 112 may directly initiate flushing of the metrics in the L1 cache to the L3 cache. This may allow the processor unit 102A to read the event values directly from memory 104 (e.g., when memory 104 represents an L3 cache) without having to request the data from the L1 cache of the processor unit 102B.

In other embodiments, the event values are kept in the L1 cache (e.g., a CLDEMOTE instruction or other actions to move the event values to a lower level cache are not performed), and instead processor unit 102A may obtain the event values from the L1 cache of processor unit 102B. For example, processor unit 102A may request a cacheline containing the target metric and after a determination that processor unit 102A does not have the cacheline cached, a cache controller may snoop one or more processor units 102B-N to determine that the cacheline is modified by processor unit 102B, and the cacheline may be updated and provided to processor unit 102A. While such requests may result in longer access times relative to direct requests by the processor unit 102A from an L3 cache, the access time may still be significantly lower than the access time for a request utilizing an inter-processor interrupt.

In various embodiments, at least a portion of the write circuitry 112 that initiates the write of the event values in registers 106 to the memory addresses is independent of a processor pipeline of the processor unit 102B that executes software instructions (e.g., the CLDEMOTE or RDMSR instructions, among others). Thus, in some embodiments, the write circuitry 112 may include special purpose circuitry to initiate the write.

In other embodiments, the write circuitry 112 (or a portion thereof) may be included within the processor pipeline. For example, in some embodiments, the initiation of the write may be performed as part of the execution of software instructions issued by the processor unit 102B including read instructions (e.g., RDMSR) to obtain the values from the event value registers 106 and write instructions (e.g., a store (STR) instruction) to cause the values to be written to the corresponding memory addresses. As described above, a processor unit 102A may then request the event values from the L1 cache of the processor unit 102B or movement of the metrics to a lower level cache may be promoted (e.g., by calling a CLDEMOTE instruction or other instruction initiating a flush of the value to a lower level cache) to allow the values to be flushed to the memory 104 (e.g., L3 cache) and then retrieved by the processor unit 102A.

In various embodiments, a software entity that is performing polling (e.g., for network packets to be processed by processor unit 102B) may issue the software instructions that initiate the write of the event values to memory 104. As one example, a poll mode driver (e.g., as defined by the Data Plane Development Kit (DPDK) available at http://git.dpdk.org/dpdk/ or similar software entity) may issue the read and write instructions at any suitable intervals to initiate the writing of the event value stored in the event value registers 106 to their respective memory addresses. Additionally, in some embodiments, the software entity may issue one or more CLDEMOTE or other instructions to promote or cause movement of the event values to other memory levels (e.g., memory 104). Because the workload running on processor unit 102B itself (as opposed to a remote processor unit 102A) is issuing the instructions to read and write the event values, an inter-processor interrupt is avoided.

A processor unit 102 may include any suitable logic that may perform the operations described herein with respect to the processor units 102. For example, a processor unit 102 may comprise a central processing unit (CPU), processor core, graphics processing unit, hardware accelerator, field programmable gate array, neural network processing unit, artificial intelligence processing unit, inference engine, data processing unit, or infrastructure processing unit. References herein to a core are contemplated to refer to any suitable processor unit where appropriate.

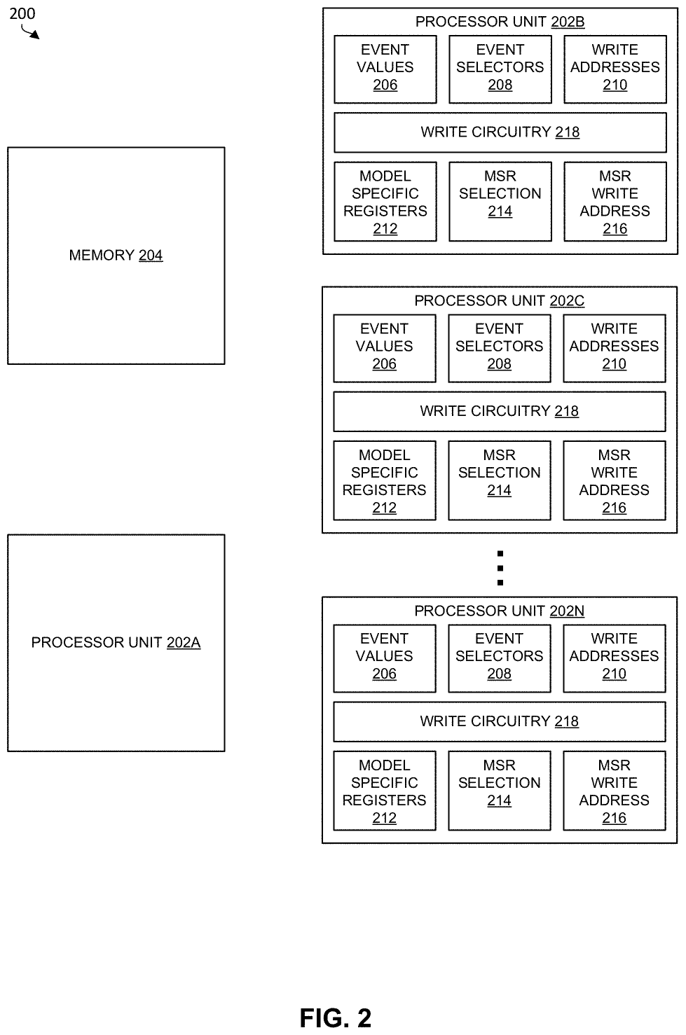

FIG. 2 illustrates another computing system 200 providing low latency metrics sharing across processor units in accordance with certain embodiments. In this embodiment, computing system 200 includes a plurality of processor units 202 (e.g., 202A-N) and a memory 204. The processor units 202 and memory 204 may have any suitable characteristics of processor units 102 and memory 104 respectively.

In the embodiment depicted, processor units 202B through 202N each include event value registers 206, event selector register 208, and write address registers 210 (which may function similarly to the corresponding components of FIG. 1). The processor units 202B-N also include model specific registers (MSRs) 212, an MSR selection register 214, and an MSR write address register 216.

In addition (or as an alternative) to the selectable events that may be tracked in the event value registers 206, the processor units 202 may store other event or status information in MSRs 212. In some embodiments, at least some of these MSRs 212 may have fixed purposes. For example, a particular MSR 212 may be dedicated to store a particular metric (and is not configurable during runtime to store a different metric). MSRs 212 may store any suitable event or status information. A few examples (of myriad metrics that could be stored in registers 212) include a counter value of the clock of the processor unit 202, the CPUID, and the current frequency setting of the processor unit 202.

The MSR selection register 214 is to store a value that indicates one or more of the MSRs 212 that are to have their values proactively written to a memory address stored in MSR write address register 216 (whereas normally the value in an MSR is only accessible via a RDMSR instruction). In one embodiment, the MSR selection register 214 may store a bitmap comprising a plurality of bits wherein each bit corresponds to an MSR 212 and the value of the bit indicates whether the corresponding MSR 212 is to be proactively written to memory 204 by the processor unit 202B. In other embodiments, the value in the MSR selection register 214 may have any other suitable format. For example, the value could include an identifier of one or more of the MSRs 212. In yet other embodiments, the MSRs that have values proactively written to a memory address may be selected in any other suitable manner.

In the embodiment depicted, the contents of the selected MSRs are written (or the write is initiated), e.g., by write circuitry 218, sequentially to memory (e.g., an L1 cache of the respective processor unit) starting at the memory address in the MSR write address register 216. In another embodiment, each MSR 212 with contents to be proactively written to the memory address may be associated with a corresponding address register that indicates the memory address to which the value in the respective MSR is to be written. This scheme is similar to the scheme described above for the event value registers 106 and their corresponding write address registers 110.

In some embodiments, the processor unit 202A may communicate to the processor units 202B-N which MSRs 212 the processor unit would like to monitor and the values for the MSR selection register 214 (e.g., the bitmask) and the MSR write address register 216 (or plurality of write addresses) may be written accordingly by the respective processor unit 202 (or 202A may directly provide the values for these registers). In various embodiments, the feature described above wherein the processor unit 202B proactively writes the MSRs 212 to the memory address(es) may be selectively enabled or disabled (e.g., as instructed by the processor unit 212A).

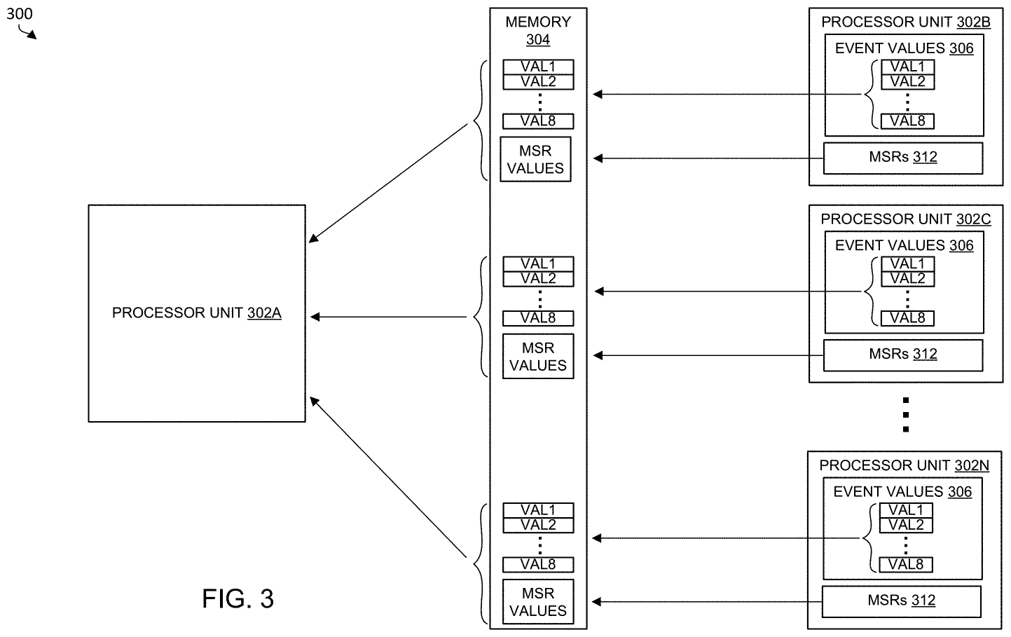

FIG. 3 illustrates a data flow of a computing system 300 providing low latency metrics sharing across processor units in accordance with certain embodiments. System 300 includes a remote processor unit 302A and a plurality of processor units 302B-302N that proactively initiate the writing of values in event value registers 306 and MSRs 312 to a memory 304. The processor units 302 and memory 304 may have any suitable characteristics of the processor units (e.g., 102 and 202) and memories (e.g., 104 and 204) described herein.

In the embodiment depicted, the event values VAL1-8 of each processor unit 302B-N are written to different locations (e.g., as defined by write address registers 210) in memory 304 (where the writes may be initiated by respective processor units 302B-N). In the embodiment depicted, these values are stored in consecutive locations of memory 304, although in other embodiments (e.g., those in which each event value register 306 has a corresponding write address), the values do not need to be written to consecutive memory locations. The values stored in selected MSRs 312 are also written to memory 304 at respective locations (e.g., as defined by an address in an MSR write address register 216) in a similar manner. Processor unit 302A may then issue memory requests to read these values from memory 304 without interrupting the workloads running on the processor units 302B-N.

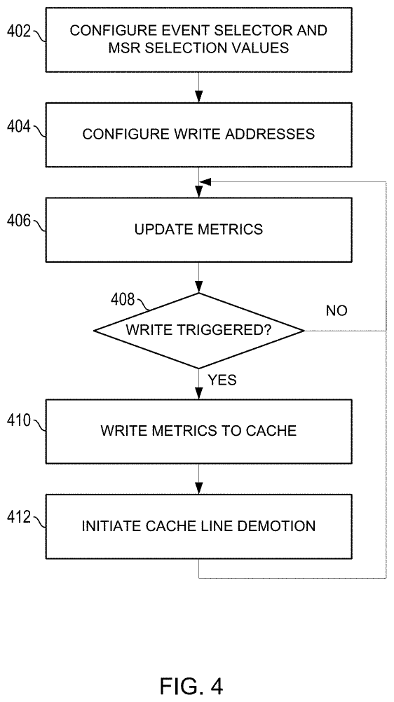

FIG. 4 illustrates a flow for providing low latency metrics sharing across processor units in accordance with certain embodiments. At 402, event selector and MSR selection values are configured. For example, event selector registers 208 may be populated with the various events that are to be monitored and the MSR selection register 214 may be populated with indications of which MSRs 212 are to be proactively written to one or more memory addresses.

At 404, write addresses are configured. This may include storing write addresses in registers to indicate where the values within event value registers 206 and the selected MSRs 212 should be written to.

At 406, the metric values are updated. For example, event values within event value registers (e.g., 206) and the values within MSRs 212 are updated. These metrics may be updated at any suitable interviews. For example, the metrics may be updated within the corresponding registers immediately each time the underlying value changes (e.g., in real time). As another example, these values may be updated every N clock cycles.

At 408, if a write of the event values and values within MSRs 212 is not triggered, then the event values and values within MSRs 212 may continue updating. If a write is triggered at 408, then the metrics (e.g., event values and values within MSRs 212) are written to an L1 cache. At 412, demotion of the cache line(s) that were written to at 410 is initiated and the flow returns to 406 where the metrics (e.g., event values and values within MSRs 212) continue to update.

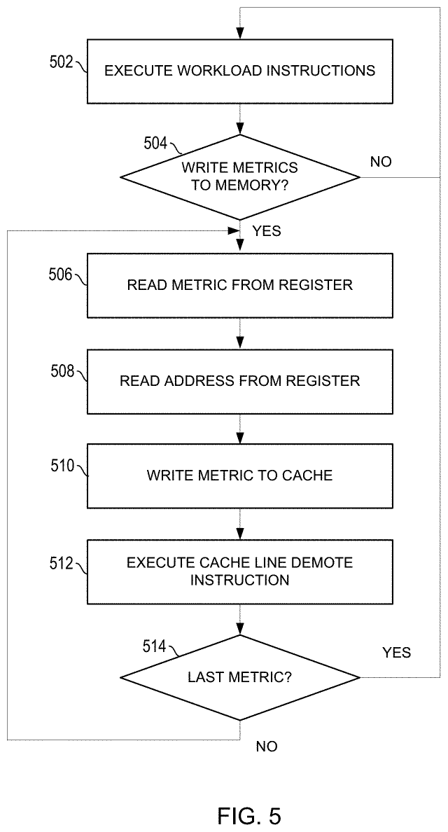

FIG. 5 illustrates a flow for providing low latency metrics sharing across processor units as part of a workload in accordance with certain embodiments. At 502, a processor unit executes workload instructions issued by a software entity. At 504, the software entity may determine whether to initiate the writing of the metrics to memory. If it is not yet time to write the metrics to memory, then the processor may continue to execute workload instructions.

If it is time to initiate the writing of the metrics to memory, then the software entity issues an instruction to read a metric from the respective register and the metric is read at 506. For example, the software entity may issue a RDMSR instruction. At 508, the software entity reads an address for the metric from a register. At 510, the software entity issues an instruction to write the metric to memory, which results in the metric being written to a cache (e.g., an L1 cache). The software entity then issues a CLDEMOTE instruction which is executed at 512.

At 514, if this was the last metric to be written to memory, the flow may loop back to 502 and execution of instructions of the workload are resumed at 502. Otherwise, the flow loops back to 506 where the next metric is written to memory in a similar fashion.

Any suitable modifications may be made to the flow. For example, in the flow of FIG. 5, a write instruction or CLDEMOTE instruction could be called once for a plurality of metrics (if the plurality of metrics are stored in the same cache line). As another example, an address may not need to be read for each metric (e.g., addresses for various metrics could be deduced from a start address for a different metric).

The flows described in FIGS. 4-5 are merely representative of operations or communications that may occur in particular embodiments. In other embodiments, additional operations may be performed or additional communications sent among the components of the systems. Various embodiments of the present disclosure contemplate any suitable signaling mechanisms for accomplishing the functions described herein. Some of the operations illustrated in FIGS. 4-5 may be repeated, combined, modified or deleted where appropriate. Additionally, operations may be performed in any suitable order without departing from the scope of particular embodiments.

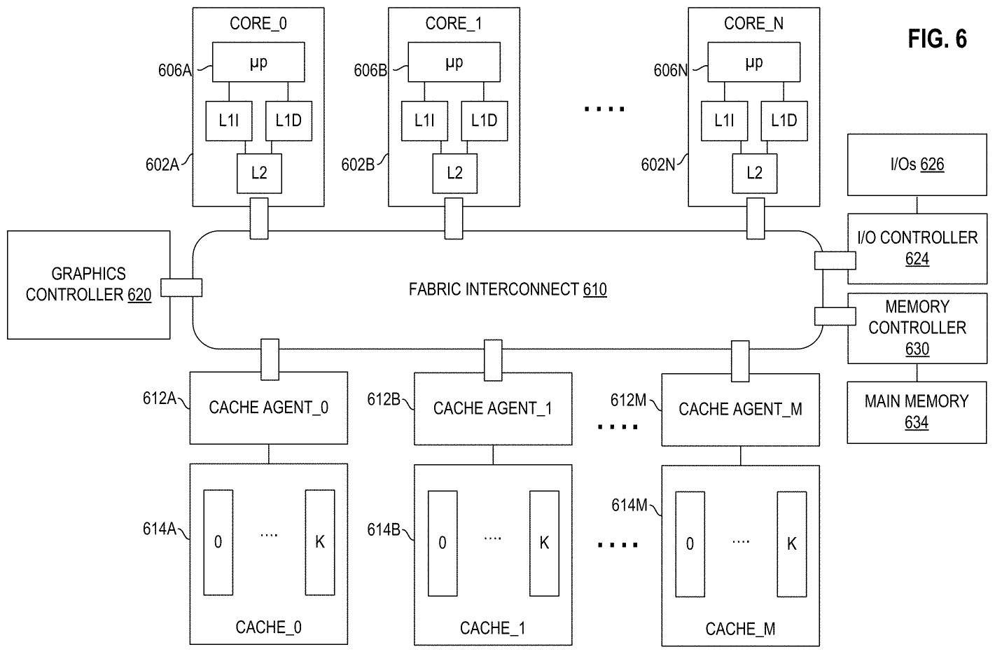

The following FIGs. depict systems and components that may be used in conjunction with the embodiments described above. For example, the systems or components depicted in the following FIGs. or components thereof may include system 100, 200, 300 or elements thereof. As just one example, processor 600 of FIG. 6 may implement one of these systems using the cache hierarchy depicted and explained below (e.g., the cache 614 could be used to implement memory 104, 204, or 304).

FIG. 6 illustrates a block diagram of a processor 600 with a plurality of cache agents 612 and caches 614 in accordance with certain embodiments. In a particular embodiment, processor 600 may be a single integrated circuit, though it is not limited thereto. The processor 600 may be part of a system on a chip in various embodiments. The processor 600 may include, for example, one or more cores 602A, 602B . . . 602N. In a particular embodiment, the cores may include a corresponding microprocessor 606A, 606B, or 606N, level one instruction (L1I) cache, level one data cache (L1D), and level two (L2) cache. The processor 600 may further include one or more cache agents 612A, 612B . . . 612M (any of these cache agents may be referred to herein as cache agent 612), and corresponding caches 614A, 614B . . . 614M (any of these caches may be referred to as cache 614). In a particular embodiment, a cache 614 is a last level cache (LLC) slice. An LLC may be made up of any suitable number of LLC slices. Each cache may include one or more banks of memory that corresponds (e.g., duplicates) data stored in system memory 634. The processor 600 may further include a fabric interconnect 610 comprising a communications bus (e.g., a ring or mesh network) through which the various components of the processor 600 connect. In one embodiment, the processor 600 further includes a graphics controller 620, an I/O controller 624, and a memory controller 630. The I/O controller 624 may couple various I/O devices 626 to components of the processor through the fabric interconnect 610. Memory controller 630 manages memory transactions to and from system memory 634.

The processor 600 may be any type of processor, including a general purpose microprocessor, special purpose processor, microcontroller, coprocessor, graphics processor, accelerator, field programmable gate array (FPGA), or other type of processor (e.g., any processor described herein). The processor 600 may include multiple threads and multiple execution cores, in any combination. In one embodiment, the processor 600 is integrated in a single integrated circuit die having multiple hardware functional units (hereafter referred to as a multi-core system). The multi-core system may be a multi-core processor package, but may include other types of functional units in addition to processor cores. Functional hardware units may include processor cores, digital signal processors (DSP), image signal processors (ISP), graphics cores (also referred to as graphics units), voltage regulator (VR) phases, input/output (I/O) interfaces (e.g., serial links, DDR memory channels) and associated controllers, network controllers, fabric controllers, or any combination thereof.

System memory 634 stores instructions and/or data that are to be interpreted, executed, and/or otherwise used by the cores 602A, 602B . . . 602N. The cores may be coupled towards the system memory 634 via the fabric interconnect 610. In some embodiments, the system memory 634 has a dual-inline memory module (DIMM) form factor or other suitable form factor.

The system memory 634 may include any type of volatile and/or non-volatile memory. Non-volatile memory is a storage medium that does not require power to maintain the state of data stored by the medium. Nonlimiting examples of non-volatile memory may include any or a combination of: solid state memory (such as planar or 3D NAND flash memory or NOR flash memory), 3D crosspoint memory, byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), a memristor, phase change memory, Spin Hall Effect Magnetic RAM (SHE-MRAM), Spin Transfer Torque Magnetic RAM (STTRAM), or other non-volatile memory devices.

Volatile memory is a storage medium that requires power to maintain the state of data stored by the medium. Examples of volatile memory may include various types of random access memory (RAM), such as dynamic random access memory (DRAM) or static random access memory (SRAM). One particular type of DRAM that may be used in a memory array is synchronous dynamic random access memory (SDRAM). In some embodiments, any portion of system memory 634 that is volatile memory can comply with JEDEC standards including but not limited to Double Data Rate (DDR) standards, e.g., DDR3, 4, and 5, or Low Power DDR4 (LPDDR4) as well as emerging standards.

A cache (e.g., 614) may include any type of volatile or non-volatile memory, including any of those listed above. Processor 600 is shown as having a multi-level cache architecture. In one embodiment, the cache architecture includes an on-die or on-package L1 and L2 cache and an on-die or on-chip LLC (though in other embodiments the LLC may be off-die or off-chip) which may be shared among the cores 602A, 602B, . . . 602N, where requests from the cores are routed through the fabric interconnect 610 to a particular LLC slice (e.g., a particular cache 614) based on request address. Any number of cache configurations and cache sizes are contemplated. Depending on the architecture, the cache may be a single internal cache located on an integrated circuit or may be multiple levels of internal caches on the integrated circuit. Other embodiments include a combination of both internal and external caches depending on particular embodiments.

During operation, a core 602A, 602B . . . or 602N may send a memory request (read request or write request), via the L1 caches, to the L2 cache (and/or other mid-level cache positioned before the LLC). In one case, a memory controller 612 may intercept a read request from an L1 cache. If the read request hits the L2 cache, the L2 cache returns the data in the cache line that matches a tag lookup. If the read request misses the L2 cache, then the read request is forwarded to the LLC (or the next mid-level cache and eventually to the LLC if the read request misses the mid-level cache(s)). If the read request misses in the LLC, the data is retrieved from system memory 634. In another case, the cache agent 612 may intercept a write request from an L1 cache. If the write request hits the L2 cache after a tag lookup, then the cache agent 612 may perform an in-place write of the data in the cache line. If there is a miss, the cache agent 612 may create a read request to the LLC to bring in the data to the L2 cache. If there is a miss in the LLC, the data is retrieved from system memory 634. Various embodiments contemplate any number of caches and any suitable caching implementations.

A cache agent 612 may be associated with one or more processing elements (e.g., cores 602) and may process memory requests from these processing elements. In various embodiments, a cache agent 612 may also manage coherency between all of its associated processing elements. For example, a cache agent 612 may initiate transactions into coherent memory and may retain copies of data in its own cache structure. A cache agent 612 may also provide copies of coherent memory contents to other cache agents.

In various embodiments, a cache agent 612 may receive a memory request and route the request towards an entity that facilitates performance of the request. For example, if cache agent 612 of a processor receives a memory request specifying a memory address of a memory device (e.g., system memory 634) coupled to the processor, the cache agent 612 may route the request to a memory controller 630 that manages the particular memory device (e.g., in response to a determination that the data is not cached at processor 600. As another example, if the memory request specifies a memory address of a memory device that is on a different processor (but on the same computing node), the cache agent 612 may route the request to an inter-processor communication controller which communicates with the other processors of the node. As yet another example, if the memory request specifies a memory address of a memory device that is located on a different computing node, the cache agent 612 may route the request to a fabric controller (which communicates with other computing nodes via a network fabric such as an Ethernet fabric, an Intel Omni-Path Fabric, an Intel True Scale Fabric, an InfiniBand-based fabric (e.g., Infiniband Enhanced Data Rate fabric), a RapidIO fabric, or other suitable board-to-board or chassis-to-chassis interconnect).

In particular embodiments, the cache agent 612 may include a system address decoder that maps virtual memory addresses and/or physical memory addresses to entities associated with the memory addresses. For example, for a particular memory address (or region of addresses), the system address decoder may include an indication of the entity (e.g., memory device) that stores data at the particular address or an intermediate entity on the path to the entity that stores the data (e.g., a computing node, a processor, a memory controller, an inter-processor communication controller, a fabric controller, or other entity). When a cache agent 612 processes a memory request, it may consult the system address decoder to determine where to send the memory request.

In particular embodiments, a cache agent 612 may be a combined caching agent and home agent, referred to herein in as a caching home agent (CHA). A caching agent may include a cache pipeline and/or other logic that is associated with a corresponding portion of a cache memory, such as a distributed portion (e.g., 614) of a last level cache. Each individual cache agent 612 may interact with a corresponding LLC slice (e.g., cache 614). For example, cache agent 612A interacts with cache 614A, cache agent 612B interacts with cache 614B, and so on. A home agent may include a home agent pipeline and may be configured to protect a given portion of a memory such as a system memory 634 coupled to the processor. To enable communications with such memory, CHAs may be coupled to memory controller 630.

In general, a CHA may serve (via a caching agent) as the local coherence and cache controller and also serve (via a home agent) as a global coherence and memory controller interface. In an embodiment, the CHAs may be part of a distributed design, wherein each of a plurality of distributed CHAs are each associated with one of the cores 602. Although in particular embodiments a cache agent 612 may comprise a cache controller and a home agent, in other embodiments, a cache agent 612 may comprise a cache controller but not a home agent.

I/O controller 624 may include logic for communicating data between processor 600 and I/O devices 626, which may refer to any suitable devices capable of transferring data to and/or receiving data from an electronic system, such as processor 600. For example, an I/O device may be a network fabric controller; an audio/video (A/V) device controller such as a graphics accelerator or audio controller; a data storage device controller, such as a flash memory device, magnetic storage disk, or optical storage disk controller; a wireless transceiver; a network processor; a network interface controller; or a controller for another input device such as a monitor, printer, mouse, keyboard, or scanner; or other suitable device.

An I/O device 626 may communicate with I/O controller 624 using any suitable signaling protocol, such as peripheral component interconnect (PCI), PCI Express (PCIe), Universal Serial Bus (USB), Serial Attached SCSI (SAS), Serial ATA (SATA), Fibre Channel (FC), IEEE 802.3, IEEE 802.11, or other current or future signaling protocol. In various embodiments, I/O devices 626 coupled to the I/O controller 624 may be located off-chip (e.g., not on the same integrated circuit or die as a processor) or may be integrated on the same integrated circuit or die as a processor.

Memory controller 630 is an integrated memory controller (e.g., it is integrated on the same die or integrated circuit as one or more cores 602 of the processor 600) that includes logic to control the flow of data going to and from system memory 634. Memory controller 630 may include logic operable to read from a system memory 634, write to a system memory 634, or to request other operations from a system memory 634. In various embodiments, memory controller 630 may receive write requests originating from cores 602 or I/O controller 624 and may provide data specified in these requests to a system memory 634 for storage therein. Memory controller 630 may also read data from system memory 634 and provide the read data to I/O controller 624 or a core 602. During operation, memory controller 630 may issue commands including one or more addresses (e.g., row and/or column addresses) of the system memory 634 in order to read data from or write data to memory (or to perform other operations). In some embodiments, memory controller 630 may be implemented in a different die or integrated circuit than that of cores 602.

Although not depicted, a computing system including processor 600 may use a battery, renewable energy converter (e.g., solar power or motion-based energy), and/or power supply outlet connector and associated system to receive power, a display to output data provided by processor 600, or a network interface allowing the processor 600 to communicate over a network. In various embodiments, the battery, power supply outlet connector, display, and/or network interface may be communicatively coupled to processor 600.

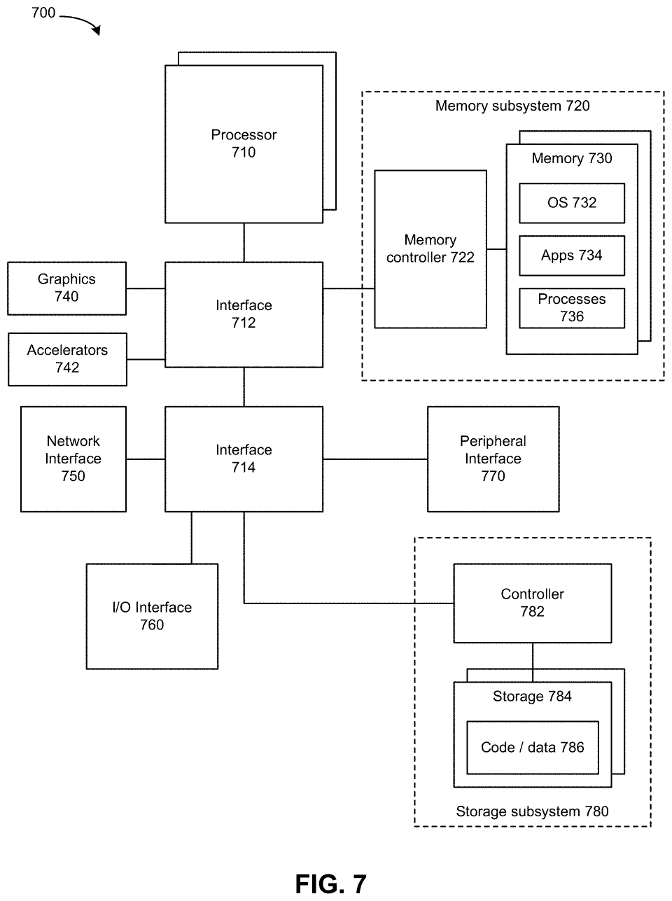

FIG. 7 depicts an example computing system. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. Various embodiments can be used in connection with network interface 750, processor 710, and memory subsystem 720.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version 3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. In various embodiments, a hybrid CTLE circuit (e.g., 100 or variations thereof) as described herein may be used to equalize a signal sent via any suitable high speed interconnect such as those described above or other suitable interconnect. Data can be copied or stored to virtualized storage nodes using a protocol such as NVMe over Fabrics (NVMe-oF) or NVMe.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

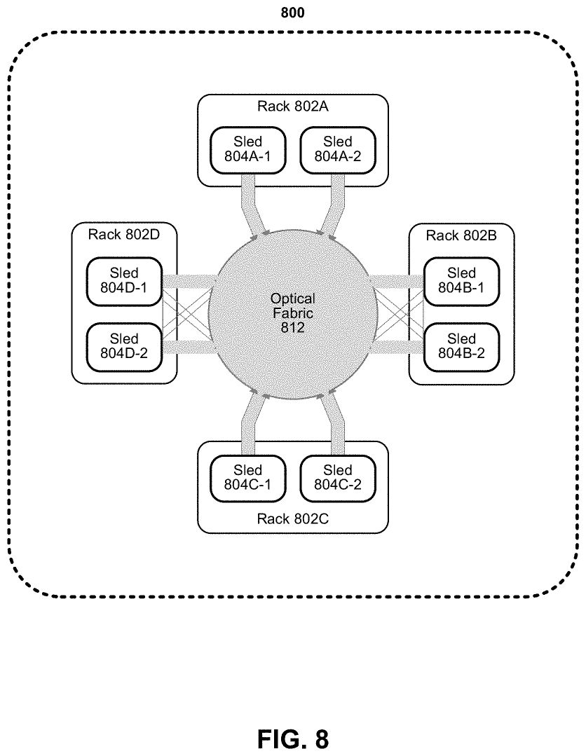

FIG. 8 depicts an example of a data center. As shown in FIG. 8, data center 800 may include an optical fabric 812. Optical fabric 812 may generally include a combination of optical signaling media (such as optical cabling) and optical switching infrastructure via which any particular sled in data center 800 can send signals to (and receive signals from) each of the other sleds in data center 800. The signaling connectivity that optical fabric 812 provides to any given sled may include connectivity both to other sleds in a same rack and sleds in other racks. Data center 800 includes four racks 802A to 802D and racks 802A to 802D house respective pairs of sleds 804A-1 and 804A-2, 804B-1 and 804B-2, 804C-1 and 804C-2, and 804D-1 and 804D-2. Thus, in this example, data center 800 includes a total of eight sleds. Optical fabric 812 can provide each sled signaling connectivity with one or more of the seven other sleds. For example, via optical fabric 812, sled 804A-1 in rack 802A may possess signaling connectivity with sled 804A-2 in rack 802A, as well as the six other sleds 804B-1, 804B-2, 804C-1, 804C-2, 804D-1, and 804D-2 that are distributed among the other racks 802B, 802C, and 802D of data center 800. The embodiments are not limited to this example.

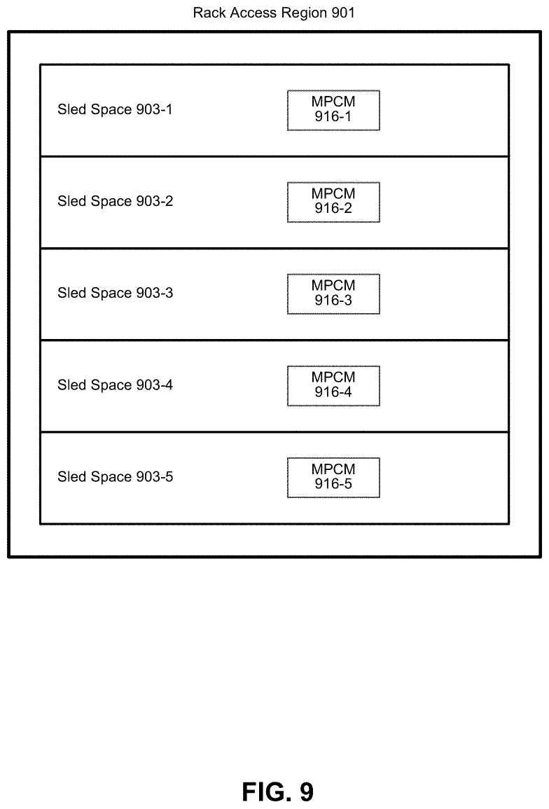

FIG. 9 depicts a rack architecture such that a plurality of sled spaces can have sleds inserted. Sled spaces can be robotically-accessible via a rack access region 901. In the particular non-limiting example, rack architecture 900 features five sled spaces 903-1 to 903-5. Sled spaces 903-1 to 903-5 feature respective multi-purpose connector modules (MPCMs) 916-1 to 916-5.

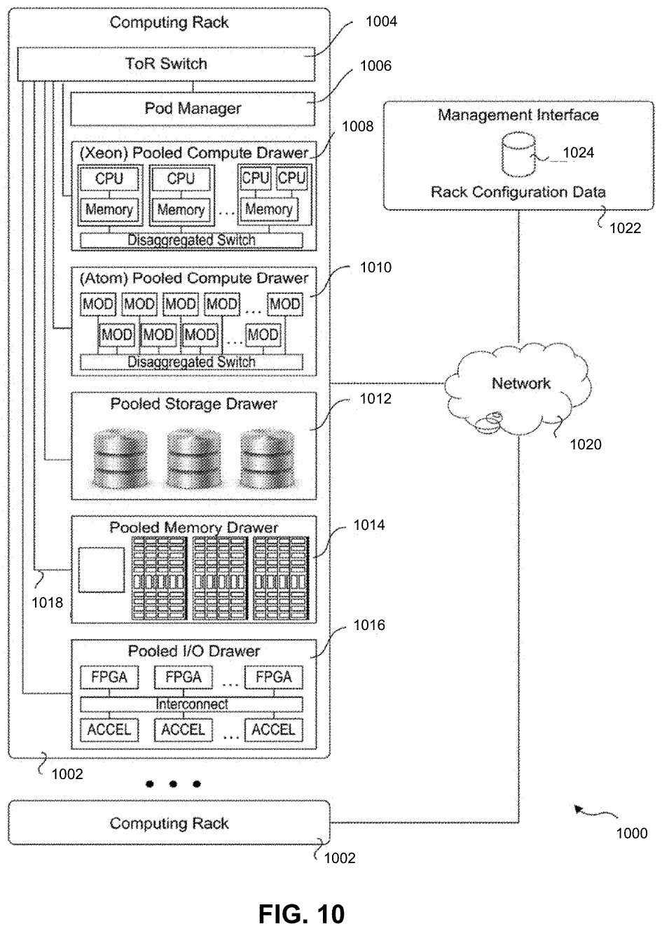

FIG. 10 depicts an environment 1000 includes multiple computing racks 1002, each including a Top of Rack (ToR) switch 1004, a pod manager 1006, and a plurality of pooled system drawers. Various embodiments can be used in a switch. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 1008, and Intel® ATOM™ pooled compute drawer 1010, a pooled storage drawer 1012, a pooled memory drawer 1014, and a pooled I/O drawer 1016. Each of the pooled system drawers is connected to ToR switch 1004 via a high-speed link 1018, such as a 40 Gigabit/second (Gb/s) or 100 Gb/s Ethernet link or a 100+ Gb/s Silicon Photonics (SiPh) optical link. In one embodiment high-speed link 1018 comprises an 800 Gb/s SiPh optical link.

Multiple of the computing racks 1002 may be interconnected via their ToR switches 1004 (e.g., to a pod-level switch or data center switch), as illustrated by connections to a network 1020. In some embodiments, groups of computing racks 1002 are managed as separate pods via pod manager(s) 1006. In one embodiment, a single pod manager is used to manage all of the racks in the pod. Alternatively, distributed pod managers may be used for pod management operations.

Environment 1000 further includes a management interface 1022 that is used to manage various aspects of the environment. This includes managing rack configuration, with corresponding parameters stored as rack configuration data 1024.

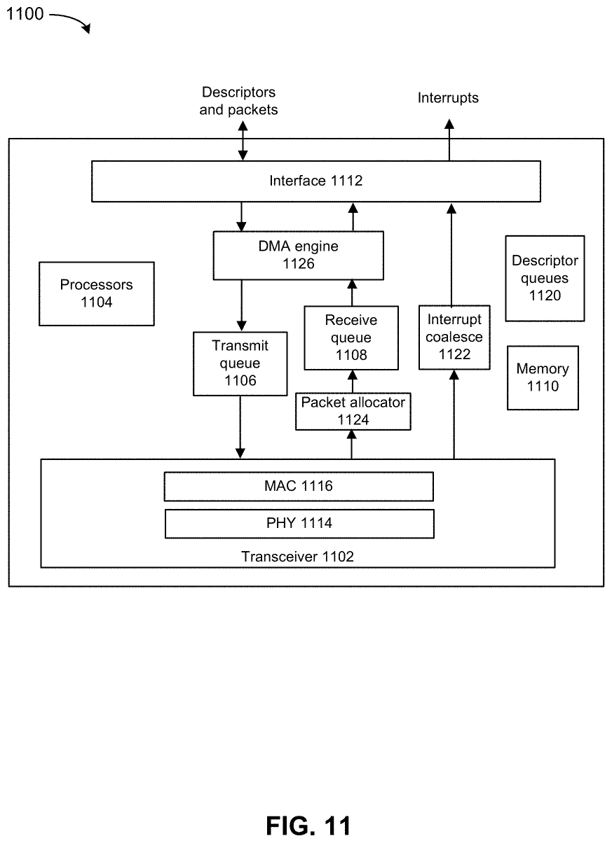

FIG. 11 depicts a network interface that can use embodiments or be used by embodiments. Various processors of network interface 1100 can use techniques described herein to provision operating parameters of a core of processors 1104. For example, if a first core of processors 1104 performs packet processing and a second core of processor 1104 performs a power management process, the second core can modify operating parameters of the first core in accordance with embodiments described herein.

Network interface 1100 can include transceiver 1102, processors 1104, transmit queue 1106, receive queue 1108, memory 1110, and bus interface 1112, and DMA engine 1126. Transceiver 1102 can be capable of receiving and transmitting packets in conformance with the applicable protocols such as Ethernet as described in IEEE 802.3, although other protocols may be used. Transceiver 1102 can receive and transmit packets from and to a network via a network medium (not depicted). Transceiver 1102 can include physical layer (PHY) circuitry 1114 and media access control (MAC) circuitry 1116. PHY circuitry 1114 can include encoding and decoding circuitry (not shown) to encode and decode data packets according to applicable physical layer specifications or standards. MAC circuitry 1116 can be configured to assemble data to be transmitted into packets, that include destination and source addresses along with network control information and error detection hash values. MAC circuitry 1116 can be configured to process MAC headers of received packets by verifying data integrity, removing preambles and padding, and providing packet content for processing by higher layers.

Processors 1104 can be any a combination of a: processor, core, graphics processing unit (GPU), field programmable gate array (FPGA), application specific integrated circuit (ASIC), or other programmable hardware device that allow programming of network interface 1100. For example, processors 1104 can provide for allocation or deallocation of intermediate queues. For example, a “smart network interface” can provide packet processing capabilities in the network interface using processors 1104.

Packet allocator 1124 can provide distribution of received packets for processing by multiple CPUs or cores using timeslot allocation described herein or RSS. When packet allocator 1124 uses RSS, packet allocator 1124 can calculate a hash or make another determination based on contents of a received packet to determine which CPU or core is to process a packet.

Interrupt coalesce 1122 can perform interrupt moderation whereby network interface interrupt coalesce 1122 waits for multiple packets to arrive, or for a time-out to expire, before generating an interrupt to host system to process received packet(s). Receive Segment Coalescing (RSC) can be performed by network interface 1100 whereby portions of incoming packets are combined into segments of a packet. Network interface 1100 provides this coalesced packet to an application.

Direct memory access (DMA) engine 1126 can copy a packet header, packet payload, and/or descriptor directly from host memory to the network interface or vice versa, instead of copying the packet to an intermediate buffer at the host and then using another copy operation from the intermediate buffer to the destination buffer.

Memory 1110 can be any type of volatile or non-volatile memory device and can store any queue or instructions used to program network interface 1100. Transmit queue 1106 can include data or references to data for transmission by network interface. Receive queue 1108 can include data or references to data that was received by network interface from a network. Descriptor queues 1120 can include descriptors that reference data or packets in transmit queue 1106 or receive queue 1108. Bus interface 1112 can provide an interface with host device (not depicted). For example, bus interface 1112 can be compatible with peripheral connect Peripheral Component Interconnect (PCI), PCI Express, PCI-x, Serial ATA (SATA), and/or Universal Serial Bus (USB) compatible interface (although other interconnection standards may be used).

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications).

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disk may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

A module as used herein or as depicted in the FIGs. refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Logic may be used to implement any of the flows described or functionality of the various systems or components described herein. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a storage device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in storage devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g. reset, while an updated value potentially includes a low logical value, e.g. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A machine-accessible/readable medium includes any mechanism that provides (e.g., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash storage devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Example 1 includes a system comprising a first processor unit comprising a first register to store a metric for the first processor unit; a second register to store a memory address associated with the metric; and circuitry to periodically initiate writing of the metric stored by the first register to the memory address to allow a second processor unit to access the metric.

Example 2 includes the subject matter of Example 1, and wherein initiating writing of the metric stored by the first register to the memory address comprises initiating writing of the metric to an L1 cache of the first processor unit at a location of the L1 cache that corresponds to the memory address.

Example 3 includes the subject matter of any of Examples 1 and 2, and wherein initiating writing of the metric stored by the first register to the memory address comprises promoting movement of the metric from an L1 cache of the first processor unit to a lower level cache.

Example 4 includes the subject matter of Example 3, and wherein promoting movement of the metric comprises executing a CLDEMOTE instruction.

Example 5 includes the subject matter of any of Examples 1-4, and wherein the circuitry is independent of a pipeline of the first processor unit that executes software instructions.

Example 6 includes the subject matter of any of Examples 1-5, and wherein the circuitry is to initiate writing of the metric responsive to software instructions to read from the first register and write to the memory address.

Example 7 includes the subject matter of Example 6, and wherein the software instructions are called by a poll mode driver executed by the first processor unit.

Example 8 includes the subject matter of any of Examples 1-7, and wherein the first processor unit further comprises a third register to store a selection value indicating a type of event that is tracked by the metric.

Example 9 includes the subject matter of any of Examples 1-8, and wherein the first processor unit comprises a plurality of first registers to store a plurality of metrics for the first processor unit; and wherein the circuitry is to periodically initiate writing of the plurality of metrics stored by the first registers to a plurality of memory addresses associated with the plurality of metrics to allow the second processor unit to access the plurality of metrics.

Example 10 includes the subject matter of Example 9, and wherein the first processor unit comprises a plurality of second registers to store the memory addresses associated with the plurality of metrics, wherein each memory address of the plurality of memory addresses corresponds to one of the metrics of the plurality of metrics.

Example 11 includes the subject matter of any of Examples 1-10, and wherein the first processor unit is to update the metric in the first register more frequently than the circuitry is to initiate writing of the metric stored by the first register to the memory address.

Example 12 includes the subject matter of any of Examples 1-11, and further including the second processor unit, wherein the second processor unit is to access the metric by reading an L3 cache at the memory address, wherein the L3 cache is shared by the first processor unit and the second processor unit.

Example 13 includes the subject matter of any of Examples 1-12, and further including a third processor unit comprising a third register to store a second metric for the second processor unit; a fourth register to store a second memory address associated with the second metric; and second circuitry to periodically initiate writing of the second metric stored by the third register to the second memory address to allow the second processor unit to access the second metric.

Example 14 includes the subject matter of any of Examples 1-13, and further including at least one of a battery, display, or network interface controller communicatively coupled to the first processor unit.

Example 15 includes a method comprising storing a metric for a first processor unit in a first register of the first processor unit; storing a memory address associated with the metric in a second register of the first processor unit; and periodically initiating a write of the metric stored by the first register to the memory address to allow a second processor unit to access the metric.

Example 16 includes the subject matter of Example 15, and wherein initiating writing of the metric stored by the first register to the memory address comprises initiating writing of the metric to an L1 cache of the first processor unit at a location of the L1 cache that corresponds to the memory address.

Example 17 includes the subject matter of any of Examples 15 and 16, and wherein initiating writing of the metric stored by the first register to the memory address comprises promoting movement of the metric from an L1 cache of the first processor unit to a lower level cache.

Example 18 includes the subject matter of Example 7, and wherein promoting movement of the metric comprises executing a CLDEMOTE instruction.

Example 19 includes the subject matter of any of Examples 15-18, and wherein periodically initiating the write is performed by circuitry that is independent of a pipeline of the first processor unit that executes software instructions.

Example 20 includes the subject matter of any of Examples 15-19, and furthering comprising initiating writing of the metric responsive to software instructions to read from the first register and write to the memory address.

Example 21 includes the subject matter of Example 20, and wherein the software instructions are called by a poll mode driver executed by the first processor unit.

Example 22 includes the subject matter of any of Examples 15-21, and further comprising storing, in a third register, a selection value indicating a type of event that is tracked by the metric.

Example 23 includes the subject matter of any of Examples 15-22, further comprising storing a plurality of metrics for the first processor unit in a plurality of first registers; and periodically initiating writing of the plurality of metrics stored by the first registers to a plurality of memory addresses associated with the plurality of metrics to allow the second processor unit to access the plurality of metrics.

Example 24 includes the subject matter of Example 23, further comprising storing, in a plurality of second registers, the memory addresses associated with the plurality of metrics, wherein each memory address of the plurality of memory addresses corresponds to one of the metrics of the plurality of metrics.

Example 25 includes the subject matter of any of Examples 15-24, further comprising updating the metric in the first register more frequently than initiating writing of the metric stored by the first register to the memory address.

Example 26 includes the subject matter of any of Examples 15-25, and further including accessing, by the second processor unit, the metric by reading an L3 cache at the memory address, wherein the L3 cache is shared by the first processor unit and the second processor unit.

Example 27 includes the subject matter of any of Examples 15-26, and further including storing a second metric for a third processor unit in a third register; storing a second memory address associated with the second metric in a fourth register; and periodically initiating writing of the second metric stored by the third register to the second memory address to allow the second processor unit to access the second metric.

Example 28 includes at least one non-transitory machine readable storage medium having instructions stored thereon, the instructions when executed by a machine to cause the machine to store a metric for a first processor unit in a first register of the processor unit; store a memory address associated with the metric in a second register of the processor unit; and periodically initiate a write of the metric stored by the first register to the memory address to allow a second processor unit to access the metric.

Example 29 includes the subject matter of Example 28, and wherein initiating writing of the metric stored by the first register to the memory address comprises initiating writing of the metric to an L1 cache of the first processor unit at a location of the L1 cache that corresponds to the memory address.

Example 30 includes the subject matter of any of Examples 28-29, wherein initiating writing of the metric stored by the first register to the memory address comprises executing an instruction to promote movement of the metric from an L1 cache of the first processor unit to a lower level cache.

Example 31 includes the subject matter of Example 30, and wherein promoting movement of the metric comprises executing a CLDEMOTE instruction.

Example 32 includes the subject matter of any of Examples 28-31, and wherein periodically initiating the write is performed by circuitry that is independent of a pipeline of the first processor unit that executes software instructions.

Example 33 includes the subject matter of any of Examples 28-32, and furthering comprising initiating writing of the metric responsive to software instructions to read from the first register and write to the memory address.

Example 34 includes the subject matter of Example 33, and wherein the software instructions are called by a poll mode driver executed by the first processor unit.

Example 35 includes the subject matter of any of Examples 28-34, and further comprising storing, in a third register, a selection value indicating a type of event that is tracked by the metric.

Example 36 includes the subject matter of any of Examples 28-35, further comprising storing a plurality of metrics for the first processor unit in a plurality of first registers; and periodically initiating writing of the plurality of metrics stored by the first registers to a plurality of memory addresses associated with the plurality of metrics to allow the second processor unit to access the plurality of metrics.

Example 37 includes the subject matter of Example 36, further comprising storing, in a plurality of second registers, the memory addresses associated with the plurality of metrics, wherein each memory address of the plurality of memory addresses corresponds to one of the metrics of the plurality of metrics.

Example 38 includes the subject matter of any of Examples 28-37, further comprising updating the metric in the first register more frequently than initiating writing of the metric stored by the first register to the memory address.

Example 39 includes the subject matter of any of Examples 28-38, and further including accessing, by the second processor unit, the metric by reading an L3 cache at the memory address, wherein the L3 cache is shared by the first processor unit and the second processor unit.

Example 40 includes the subject matter of any of Examples 28-39, and further including storing a second metric for a third processor unit in a third register; storing a second memory address associated with the second metric in a fourth register; and periodically initiating writing of the second metric stored by the third register to the second memory address to allow the second processor unit to access the second metric.

Example 41 includes a system comprising means to perform the methods of any of Examples 15-27.

What is claimed is:

1. A system comprising:
a first processor unit comprising:
a first register to store a metric for the first processor unit; and
circuitry to initiate sharing of the metric with a second processor unit without the use of an inter-processor interrupt.

2. The system of claim 1, the first processor unit further comprising:
a second register to store a memory address associated with the metric; and
wherein the circuitry is to periodically initiate writing of the metric stored by the first register to the memory address to allow the second processor unit to access the metric.

3. The system of claim 2, wherein initiating writing of the metric stored by the first register to the memory address comprises initiating writing of the metric to an L1 cache of the first processor unit at a location of the L1 cache that corresponds to the memory address.

4. The system of claim 2, wherein initiating writing of the metric stored by the first register to the memory address comprises promoting movement of the metric from an L1 cache of the first processor unit to a lower level cache.

5. The system of claim 4, wherein promoting movement of the metric comprises executing an instruction facilitating demotion of a cacheline.

6. The system of claim 2, wherein the circuitry is independent of a pipeline of the first processor unit that executes software instructions.

7. The system of claim 2, wherein the circuitry is to initiate writing of the metric responsive to software instructions to read from the first register and write to the memory address.

8. The system of claim 7, wherein the software instructions are called by a poll mode driver executed by the first processor unit.

9. The system of claim 2, wherein the first processor unit further comprises a third register to store a selection value indicating a type of event that is tracked by the metric.

10. The system of claim 2, wherein the first processor unit comprises:
a plurality of first registers to store a plurality of metrics for the first processor unit; and
wherein the circuitry is to periodically initiate writing of the plurality of metrics stored by the first registers to a plurality of memory addresses associated with the plurality of metrics to allow the second processor unit to access the plurality of metrics.

11. The system of claim 10, wherein the first processor unit comprises a plurality of second registers to store the memory addresses associated with the plurality of metrics, wherein a memory address of the plurality of memory addresses corresponds to one of the metrics of the plurality of metrics.

12. The system of claim 2, wherein the first processor unit is to update the metric in the first register more frequently than the circuitry is to initiate writing of the metric stored by the first register to the memory address.

13. The system of claim 2, further comprising the second processor unit, wherein the second processor unit is to access the metric by reading an L3 cache at the memory address, wherein the L3 cache is shared by the first processor unit and the second processor unit.

14. The system of claim 2, further comprising a third processor unit comprising:
a third register to store a second metric for the third processor unit;
a fourth register to store a second memory address associated with the second metric; and
second circuitry to periodically initiate writing of the second metric stored by the third register to the second memory address to allow the second processor unit to access the second metric.

15. The system of claim 1, further comprising at least one of a battery, display, or network interface controller communicatively coupled to the first processor unit.

16. A method comprising:
storing a metric for a first processor unit in a first register of the first processor unit; and
initiating sharing of the metric with a second processor unit without the use of an inter-processor interrupt.

17. The method of claim 16, further comprising:
storing a memory address associated with the metric in a second register of the first processor unit; and
periodically initiating a write of the metric stored by the first register to the memory address to allow a second processor unit to access the metric.

18. The method of claim 17, wherein initiating writing of the metric stored by the first register to the memory address comprises initiating writing of the metric to an L1 cache of the first processor unit at a location of the L1 cache that corresponds to the memory address.

19. The method of claim 17, wherein initiating writing of the metric stored by the first register to the memory address comprises promoting movement of the metric from an L1 cache of the first processor unit to a lower level cache.

20. At least one non-transitory machine readable storage medium having instructions stored thereon, the instructions when executed by a machine to cause the machine to:
store a metric for a first processor unit in a first register of the first processor unit;
initiate sharing of the metric with a second processor unit without the use of an inter-processor interrupt.

21. The medium of claim 20, the instructions to further cause the machine to:
store a memory address associated with the metric in a second register of the first processor unit; and
periodically initiate a write of the metric stored by the first register to the memory address to allow a second processor unit to access the metric.

22. The medium of claim 21, wherein initiating writing of the metric stored by the first register to the memory address comprises initiating writing of the metric to an L1 cache of the first processor unit at a location of the L1 cache that corresponds to the memory address.

23. The medium of claim 21, wherein initiating writing of the metric stored by the first register to the memory address comprises executing an instruction to promote movement of the metric from an L1 cache of the first processor unit to a lower level cache.
